(19) United States
(12) Patent Application Publication
(10) Pub. No.: US 2015/0154028 A1
(43) Pub. Date: Jun. 4, 2015

(54) METHODS FOR ACCESSING BASEBOARD MANAGEMENT CONTROLLER

(71) Applicants: INVENTEC CORPORATION, Taipei City (TW); INVENTEC (PUDONG) TECHNOLOGY CORPORATION, Shanghai (CN)

(72) Inventor: TING-TING CHEN, Shanghai City (CN)

(73) Assignees: INVENTEC CORPORATION, Taipei City (TW); INVENTEC (PUDONG) TECHNOLOGY CORPORATION, Shanghai (CN)

(21) Appl. No.: 14/168,516

(22) Filed: Jan. 30, 2014

(30) Foreign Application Priority Data
Nov. 29, 2013 (CN) 201310631655.4

(51) Int. Cl. G06F 9/44

(52) U.S. Cl. CPC G06F 9/4401

(57) ABSTRACT

Disclosed herein are methods for accessing the baseboard management controller (BMC) in the Intelligent Platform Management Interface (IPMI). A BMC of a server sets a first privilege key based on a key setting command. In one embodiment, a basic input/output system (BIOS) of the server sends the BMC a data reading command, which has the first privilege key and according to which the BMC then sends a BIOS setting to the BIOS. In another embodiment, the BIOS sends the BMC a BIOS setting, which has the first privilege key and is then saved by the BMC in a non-volatile memory.

### CROSS-REFERENCE TO RELATED APPLICATIONS

This non-provisional application claims priority under 35 U.S.C. §119(a) on Patent Application No. 201310631655.4 filed in People's Republic of China on Nov. 29, 2013, the entire contents of which are hereby incorporated by reference.

### TECHNICAL FIELD

The present invention relates to server technology, particularly to methods for accessing baseboard management controller.

### BACKGROUND

A server providing the Intelligent Platform Management Interface (IPMI) is equipped with a baseboard management controller (BMC) independent of the central processing unit (CPU). The BMC monitors sensors at multiple locations within the server to get a handle of and automatically report the temperature, power stability, and other operational status of the server. Depending on the implementation, the BMC may be connected with the southbridge, Super I/O (an integrated module of input/output controllers), network interface cards, etc. as the processing core of the IPMI. With the BMC catering to so many connections, which in turn are local hubs on the motherboard, access conflict is bound to occur when signals from different parts of the server reach the BMC at around the same time.

### SUMMARY

In light of the above, the present invention discloses methods for eliminating conflict or interference while accessing a baseboard management controller (BMC).

In one method provided by this disclosure, a BMC of a server sets a first privilege key based on a key setting command. A basic input/output system (BIOS) of the server then sends the BMC a data reading command having the first privilege key. Based on the data reading command, the BMC sends a BIOS setting to the BIOS.

In another method provided by this disclosure, a BMC of a server sets a first privilege key based on a key setting command. A BIOS of the server then sends the BMC a BIOS setting having the first privilege key. The BIOS setting is stored in a non-volatile memory by the BMC.

In short, by prescribing the first privilege key to the BMC, data can be smoothly exchanged between the BIOS and the BMC without interference from other components of the server trying to access the BMC.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a high-level block diagram of a server, in accordance with one embodiment of the present invention.

FIG. 2 is a flowchart of a method for accessing BMC, in accordance with one embodiment of the present invention.

FIG. 3 is a flowchart of a method for accessing BMC, in accordance with another embodiment of the present invention.

FIG. 4 is a flowchart of a method for accessing BMC, in accordance with yet another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

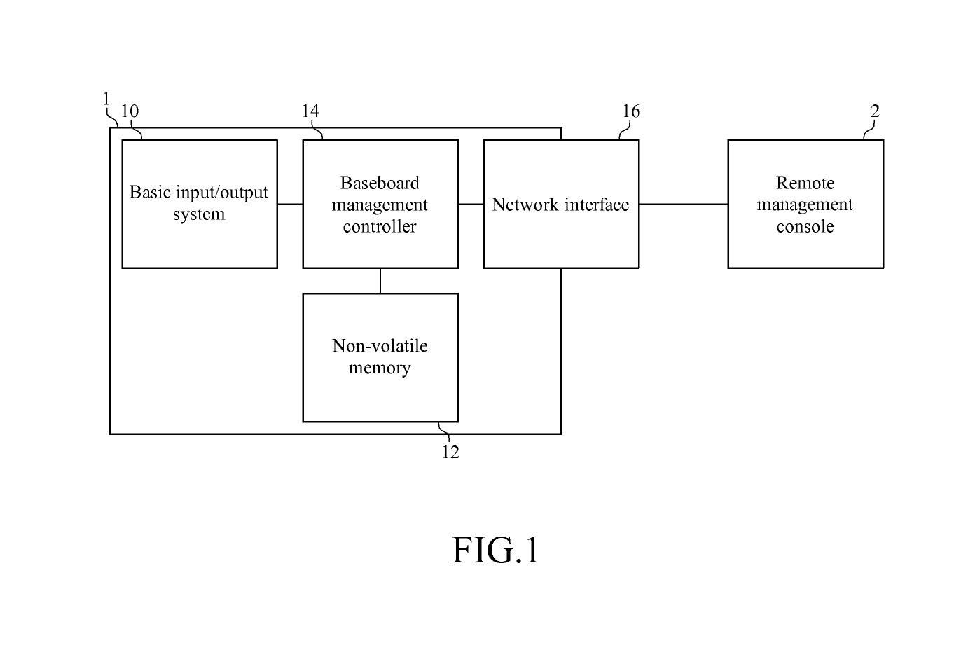

Please refer to FIG. 1. As shown in this high-level block diagram, in one embodiment, a server 1 comprises a basic input/output system (BIOS) 10, a baseboard management controller (BMC) 14, a network interface 16, and a non-volatile memory 12. The BMC 14, in one embodiment capable of causing the server 1 to start up or shut down, is coupled to a remote management console 2 through the network interface 16 and a network. In another embodiment, the sever 1 is started up with the use of a power button on a motherboard of the sever 1. The non-volatile memory 12 may be flash memory, other types of electrically erasable programmable read-only memory (EEPROM), or other non-volatile storage coupled with the BMC 14 on, for example, an I²C (Inter-Integrated Circuit) or a SPI (Serial Peripheral Interface) bus. To streamline the description, the central processing unit (CPU), volatile random-access memory used by the CPU (e.g. a dual in-line memory module or DIMM), heat-dissipation modules, power supply, hard disk drives, RAID (redundant array of independent disks) card, sensors for the aforementioned hardware, etc. that the server 1 may further include are not depicted in FIG. 1.

The operation of the BIOS 10 involves the CPU and a dedicated read-only memory storing the machine code that the CPU first reads according to its program counter when the server 1 is powered on. The CPU is bestowed with the capabilities of the BIOS 10 by executing this machine code. Generally speaking, the BIOS 10 can be seen as a complete and independent function block. The coupling between the BIOS 10 and the BMC 14 may be, but is not limited to, a LPC (Low Pin Count) bus. A backup setting stored in the non-volatile memory 12 is available to the BIOS 10 through the BMC 14 in the present invention.

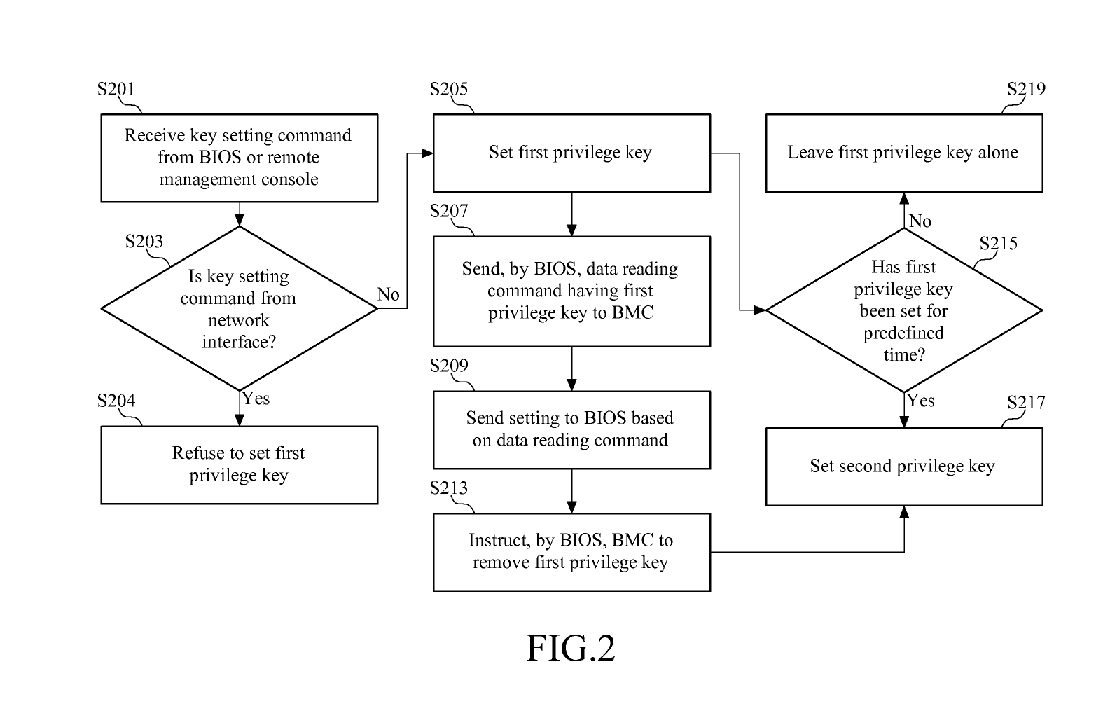

Please refer to FIG. 2 with regard to FIG. 1. The flowchart illustrates the method for accessing the BMC 14 when a read signal is originated in the BIOS 10. As shown in FIG. 2, in step S201 the BMC 14 receives from the BIOS 10 or the remote management console 2 a key setting command instructing the BMC 14 to set a first privilege key. The BMC 14 determines in step S203 whether the key setting command is from the network interface 16. If it is, the key setting command must have been sent by the remote management console 2; otherwise, it is from the BIOS 10, and the BMC 14 sets the first privilege key in step S205. The setting of a privilege key may involve the BMC 14 modifying a flag or data structure or recording a number in its internal cache or in the non-volatile memory 12. In one embodiment, the first privilege key set in the BMC 14 is only allowed to exist for a certain amount of time (three minutes, for instance), so the BMC 14 also begins a countdown after step S205 with periodic executions of step S215, where the BMC 14 leaves the first privilege key alone during the countdown (step S219) unless otherwise instructed (see step S213). If the key setting command is not of BIOS origin but from, say, the remote management console 2 through the network interface 16, the BMC 14 may ignore the command, refuse to set the first privilege key, and report an error in step S204. Steps S203 and S204 aim to block any attempt by the remote management console 2 to set the first privilege key.

Once the first privilege key is set, in step S207 the BIOS 10 sends a data reading command, based on which the BMC 14 reads from the non-volatile memory 12 and sends to the BIOS 10 a BIOS setting in step S209. Please note that the BMC 14 only performs step S209 when the data reading command sent by the BIOS 10 has the first privilege key. In one embodiment, the BIOS 10 stores the received BIOS setting in a complementary metal-oxide-semiconductor (CMOS) memory chip, replacing whatever BIOS setting was previously kept therein. After a restart of the server 1, the BIOS 10 loads the setting from the CMOS memory chip to become operational.

In one embodiment, any access to the BIOS setting includes taking the setting as a bit string and calculating a verification value thereof so as to verify the correctness and authenticity of the bits. The verification value may be a simple checksum or a hash value, such as the outcome of a function of the CRC (cyclic redundancy check) series. The calculation of verification values may be performed by the BIOS 10, the BMC 14, other circuitry on the motherboard, or the remote management console 2.

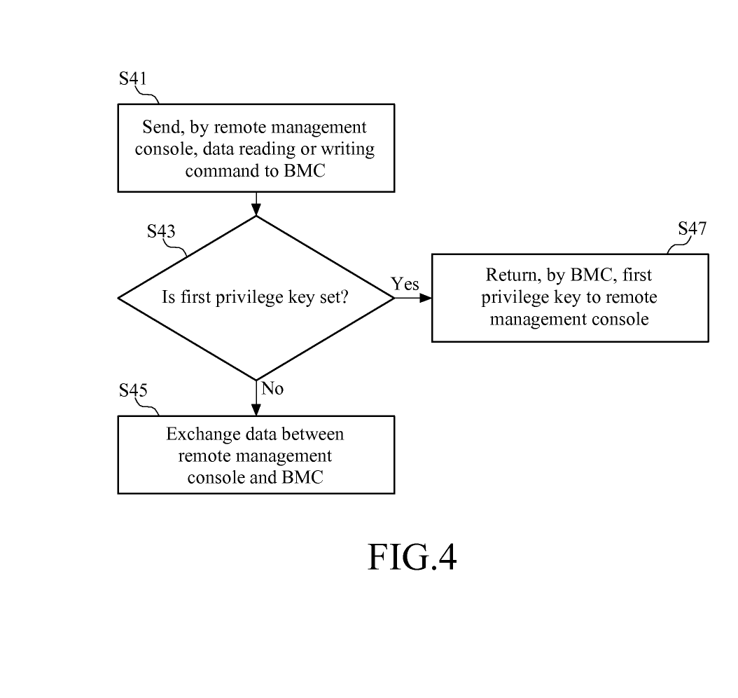

In step S213, the BIOS 10 instructs the BMC 14 to remove the first privilege key, which is therefore replaced with a second privilege key set by the BMC 14 in step S217. In one embodiment, step S217 is also executed to automatically restore or set the second privilege key when it is determined in step S215 that time is up for the first one. The countdown is useful in excluding the possibility that the first privilege key is permanently set in the BMC 14 when the BIOS 10 encounters a runtime error (e.g. when the server 1 is abnormally shut down) after step S205 and fails to execute step S213, leaving the BMC 14 inaccessible to the remote management console 2 (see FIG. 4).

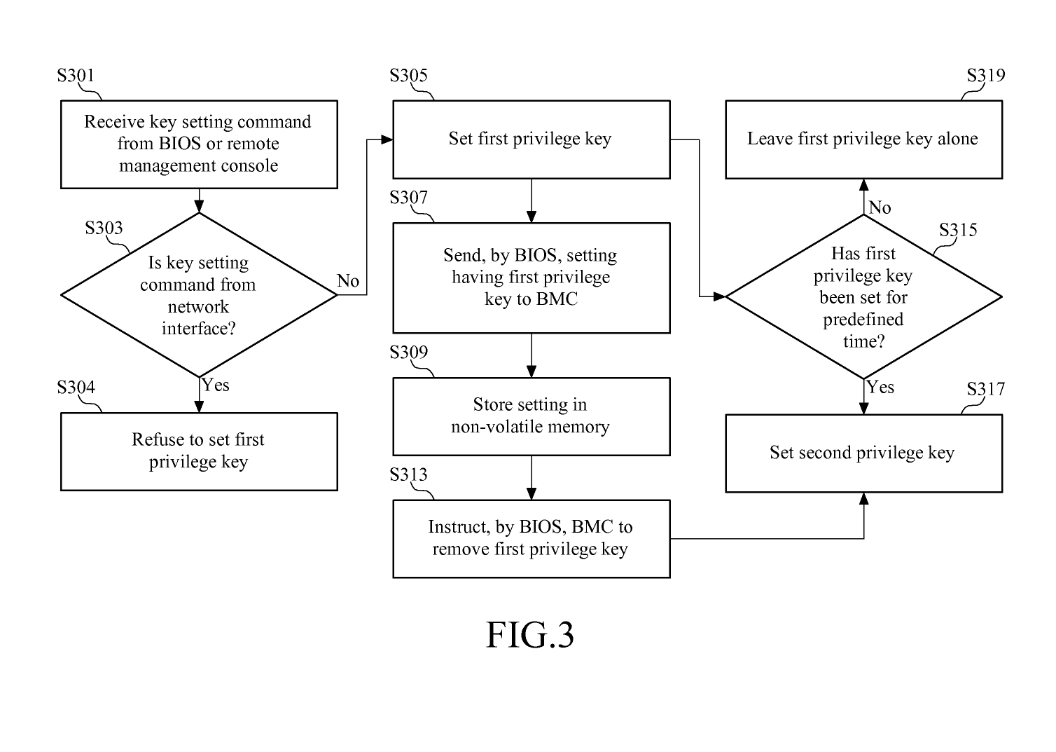

Please refer to FIG. 3 with regard to FIGS. 1 and 2. The flowchart illustrates the method for accessing the BMC 14 when a write signal is originated in the BIOS 10. Steps S301 through S305 correspond to steps S201 through S205; steps S313 through S319 correspond to steps S213 through S219. The difference between FIGS. 3 and 2 lies in step S307, where the BIOS 10 sends the BMC 14 a BIOS setting having the first privilege key, and in step S309, where the setting is saved in the non-volatile memory 12 by the BMC 14.

Please refer to FIG. 4 with regard to FIG. 1. The flowchart illustrates the method for accessing the BMC 14 when an access signal is originated in the remote management console 2. As shown in FIG. 4, in step S41 the BMC 14 receives from the remote management console 2 through the network interface 16 a data reading or writing command having the second privilege key. If the first privilege key is set (step S43), it is returned to the remote management console 2 in step S47 by the BMC 14 as an indication to the remote management console 2 that data is being exchanged between the BMC 14 and the BIOS 10. Consequently the remote management console 2 is denied data access to the BMC 14. If, however, the first privilege key is not set, then the remote management console 2 can exchange data with the BMC 14 using the second privilege key in step S45, which is similar to steps S207 and S209.

To summarize, by prescribing the first and second privilege keys to the BMC, a pecking order is established for at least two signal sources. The BMC only handles access from a single source at a given time, avoiding synchronization issues. Only when the same privilege key is set by the BMC and recorded in the data reading or writing command does the BMC access data based on the command. Most importantly, transmission of the BIOS setting between the BIOS and the BMC is devoid of interference from the remote management console.

What is claimed is:

1. A method for accessing baseboard management controller (BMC), comprising:
setting, by a BMC of a server, a first privilege key based on a key setting command;
sending, by a basic input/output system (BIOS) of the server, a data reading command to the BMC, the data reading command having the first privilege key; and
sending, by the BMC, a BIOS setting to the BIOS, based on the data reading command.

2. The method of claim 1, wherein when the first privilege key is set by the BMC and a remote management console connected to the BMC sends the BMC a data writing command or the data reading command, the BMC returns the first privilege key to the remote management console, denying the remote management console data access to the BMC.

3. The method of claim 1, wherein the BMC is connected to a remote management console through a network interface, the method further comprising:
receiving, by the BMC, the key setting command from the BIOS or the remote management console; and
determining, by the BMC, whether the key setting command is from the network interface;
wherein the BMC refuses to set the first privilege key when the key setting command is from the network interface.

4. The method of claim 3, wherein the BMC sets the first privilege key based on the key setting command when the key setting command is not from the network interface.

5. The method of claim 1, wherein the BMC removes the first privilege key set in the BMC when the first privilege key has been set by the BMC for a predefined time.

6. The method of claim 5, wherein removing the first privilege key set in the BMC comprises replacing, by the BMC, the first privilege key with a second privilege key, which is used by a remote management console to exchange data with the BMC, the remote management console connected to the BMC through a network interface.

7. The method of claim 1, wherein the BIOS instructs the BMC to remove the first privilege key set in the BMC after the BMC has sent the BIOS setting to the BIOS.

8. The method of claim 7, wherein removing the first privilege key set in the BMC comprises replacing, by the BMC, the first privilege key with a second privilege key, which is used by a remote management console to exchange data with the BMC, the remote management console connected to the BMC through a network interface.

9. The method of claim 1, further comprising:
storing, by the BIOS, the BIOS setting in a memory;
restarting the server; and
loading, by the BIOS, the BIOS setting from the memory;
wherein the memory is a complementary metal-oxide-semiconductor memory chip.

10. The method of claim 9, wherein restarting the server comprises instructing, by the BMC, the server to restart.

11. A method for accessing baseboard management controller (BMC), comprising:
setting, by a BMC of a server, a first privilege key based on a key setting command;
sending, by a basic input/output system (BIOS) of the server, a BIOS setting to the BMC, the BIOS setting having the first privilege key; and
storing, by the BMC, the BIOS setting in a non-volatile memory.
